(19) United States
(12) Patent Application Publication
(10) Pub. No.: US 2011/0258284 A1
(43) Pub. Date: Oct. 20, 2011

(54) METHOD, DEVICE AND COMPUTER PROGRAM PRODUCT FOR REPRESENTING A PARTITION OF N W-BIT INTERVALS ASSOCIATED TO D-BIT DATA IN A DATA COMMUNICATIONS NETWORK

(76) Inventor: Mikael ... Sundstrom, Lulea (SE)

(21) Appl. No.: 13/063,529

(22) PCT Filed: Sep. 29, 2009
(86) PCT No.: PCT/SE2009/051079

§ 371 Date: Jun. 27, 2011

(30) Foreign Application Priority Data
Oct. 3, 2008 (SE) 08020877

(51) Int. Cl. G06F 15/167

(52) U.S. Cl. 709/215

(57) ABSTRACT

The present invention relates to a method for routing in a data communications network, comprising the steps of providing in a storage having a certain amount of storage capacity, a datagram forwarding data structure provided for indicating where to forward a datagram in said network, which data structure is in the form of a block tree, or fixed stride trie, comprising at least one leaf and possibly a number of nodes including partial nodes, said data structure having a height, corresponding to a number of memory accesses required for lookup in an arbitrary partition comprising n intervals, step 201 reducing worst storage cost by using a technique for reduction of worst case storage cost that are selectable from: partial block tree compaction, virtual blocks, bit push pulling, block aggregation or split block trees, and variations thereof, step 202 updating the layered data structure partially by using a technique for scheduling maintenance work that are selectable from: vertical segmentation and bucket list maintenance, step 203, further comprising the step of using a certain maximum amount of storage capacity for storing a maximal number of keys having a particular size, step 204.

### TECHNICAL FIELD

The present invention relates to a method for representing a partition of n w-bit intervals associated to d-bit data in a data communications network. The present invention also relates to a device and a computer program product for performing the method.

### BACKGROUND

Internet is formed of a plurality of networks connected to each other, wherein each of the constituent networks maintains its identity. Each network supports communication among devices connected to the networks, and the networks in their turn are connected to each other by routers. Thus, Internet can be considered to comprise a mass of routers interconnected by links. Communication among nodes (routers) on Internet takes place using an Internet protocol, commonly known as IP. Data sent or received over a public network such as the Internet travels as a series of datagrams. Datagrams, typically IP datagrams, are transmitted over data paths from one router to the next one on their ways towards the final destinations. In each router, a forwarding decision is performed on incoming datagrams to determine the datagrams next-hop router. For example, every e-mail that a user sends leaves as a series of data packets and every web page that a user receives comes as a series of data packets.

Herein, the term “datagram” includes, but is not limited to data packets.

A datagram consists of a header together with the piece of data and the header per se consists of a number of fields, where each field contains information such as where the datagram comes from and where it should be sent.

When the datagrams travel on the Internet they are sorted into different flows according to one or several fields in the headers. The header fields used to sort a datagram into the right flow are referred to as the input key.

In order to know to which flow a datagram belongs a router is used. The router partitions the Internet into smaller sub-networks and a datagram visits a number of routers when it travels through the Internet.

The router uses the input key to search for the corresponding flow that the datagram belongs to. The search is done in a table called a classifier. The classifier consists of a list of rules. Typically, each rule consists of D fields and represents a flow. A datagram matches a rule if the header fields in the input key matches the corresponding fields in the rule.

In other words, a routing or forwarding decision is normally performed by a lookup procedure in a forwarding data structure such as a routing table. Thus, routers do a routing lookup in the routing table to obtain next-hop information about where to forward the datagrams on their path toward their destinations. A routing lookup operation on an incoming datagram requires the router to find the most specific path for the datagram. This means that the router has to solve the so-called “longest prefix matching problem”, which is the problem of finding the next-hop information (or index) associated with the longest address prefix matching the incoming data grams destination address in a set of arbitrary length (i.e. between 3 and 65 bits) prefixes constituting the routing table.

To speed up the forwarding decisions, many router designs of today use a caching technique, wherein the most recently or most frequently looked up destination addresses and the corresponding routing lookup results are kept in a route cache. This method works quite well for routers near the edges of the network, i.e. so called small office and home office (SOHO) routers having small routing tables, low traffic loads, and high locality of accesses in the routing table.

Another method of speeding up the routers is to exploit the fact that the frequency of routing table updates, resulting from topology changes in the network etc., is extremely low compared to the frequency of routing lookups. This makes it feasible to store the relevant information from the routing table in a more efficient so-called “forwarding table” optimized for supporting fast lookups.

In this context, a forwarding table is an efficient representation of a routing table and a routing table is a dynamic set of address prefixes. Each prefix is associated with next hop information, i.e. information about how to forward an outgoing packet and the rules of the game state that the next-hop information associated with the longest matching prefix of the destination address (of the packet) must be used. When changes to the routing table occur, the forwarding table is partially or completely rebuilt.

An example of a forwarding data structure is a so-called “static block tree”, which is a comparison based data structure for representing w-bit non-negative integers with d-bit data and supporting extended search in time proportional to the logarithm with base B, where B−1 is the number of integers that can be stored in one memory block, of the number of integers stored. Typically, it is a static data structure which supports efficient extended search with minimum storage overhead. The static block tree data structure has previously been described in the Swedish patent 0200153-5, which refers to a method and system for fast IP routing lookup using forwarding tables with guaranteed compression ratio and lookup performance where it is referred to as a Dynamic Layered Tree and also in M. Sundström and Lars-Ake Larzon, High-Performance Longest Prefix Matching supporting High-Speed Incremental Updates and Guaranteed Compression, IEEE INFOCOMM, Miami Fla., USA, 2005.

A basic block tree, for instance in the form of a dynamic layered tree, consists of at least one leaf and possibly a number of nodes if the height is larger than one. The height corresponds to the number of memory accesses required for looking up the largest stored non-negative integer smaller than or equal to an input key, in the following referred to as “key”. This kind of lookup operation is referred to as extended search.

The problem solved by a basic block tree is to represent a partition, of a totally ordered universe U, consisting of n basic intervals. Since U is known, also minU and maxU are known. Therefore, it is sufficient to represent n−1 interval boundaries where each interval boundary is represented by an element which is a w-bit non-negative integer. The w-bit non-negative integer is referred to as the key and the corresponding d-bit data field as the data. In one memory block, we can store B elements and thus represent B+1 intervals. We call the resulting data structure a basic block tree of height 1. Each basic interval constitutes a subset of U. For each subset, we can recursively represent a partition consisting of B+1 intervals by using one additional memory block. By combining the original partition of U with the B+1 sub-partitions, we obtain a block tree of height 2 representing (B+1)² basic intervals. Assuming that pointers to sub-structures can be encoded implicitly, it is possibly to recursively construct a block tree of arbitrary height t for representing up to (B+1)^{t} basic intervals.

A block tree of height t that represents exactly (B+1)^{t} intervals is said to be complete. Otherwise it is partial. The need for pointers is avoided by storing a block tree in a consecutive array of memory blocks. To store a block tree of height t, first the root block is stored in the first location. This is followed by up to B+1 recursively stored complete block trees of height t−1 and possibly one recursively stored partial block tree of height t−1. No pointers are needed since the size s(t−1) of a complete block tree of height t−1 can be computed in advance. The root of sub-tree i is located i·s(t−1) memory blocks beyond the root block (assuming that the first sub-tree has index zero).

Typically, there are two major problems with basic block trees. The first problem is related to worst case storage cost. More precisely, the worst case amortized number of bits required for storing n keys and their corresponding data may be considerably larger than n·(w+d) in the worst case resulting in a worst case cost per key of much more than w+d bits which is optimal (at least in a sense). The second problem is related to incremental updates. A basic block tree is essentially static which means that the whole data structure must be rebuilt from scratch when a new key and data is inserted or deleted. As a result, the cost for updates is too high, i.e. at least in some applications, it takes too much time and computation, in particular if the block tree is large. In addition to these two problems, there is a third problem associated with block trees related to handling keys of different sizes.

### SUMMARY OF THE INVENTION

The present invention aims to solve the above mentioned problem with handling keys of different sizes.

According to a first aspect of the present invention, this is provided by a method, wherein a certain maximum amount of storage capacity is provided for storing a maximal number of keys having a particular size. This type of block tree could be called a “reconfigurable block tree”.

According to another aspect of the present invention, there is provided a method for representing a partition of n w-bit intervals associated to d-bit data in a data communications network. The method comprises the steps of: providing in a storage having a certain amount of storage capacity for keys, a datagram forwarding data structure provided for indicating where to forward a datagram in said network, which data structure is in the form of a block tree, or fixed stride trie, comprising at least one leaf and possibly a number of nodes including partial nodes, said data structure having a height, corresponding to a number of memory accesses required for lookup in an arbitrary partition comprising n intervals, partitioning the memory such that a certain part or portion of the total storage is designated for a particular key size.

Typically, it is desirable from a storage efficiency point of view to represent the block trees such that n1*w1+n2*w2+n3*w3=S, where n1*W1 is the number of keys of size w1, etc. and S is the total amount of memory available.

According to another aspect of the present invention, the method further comprises the step of partitioning the storage at system start-up. This type of block tree could be called “a static reconfigurable block tree”.

According to an alternative aspect of the present invention, there is provided a fully dynamic reconfigurable block tree that supports on-the-fly re-partitioning during run-time and smoothly adapts as new keys are inserted.

According to yet another aspect of the present invention, there is provided, a semi-dynamic reconfigurable block tree which supports partitioning at system start-up as well as re-partitioning during run-time.

While the illustrations and the description includes static block trees as examples and embodiments thereof, the invention is not limited to a static data structure in the form of a block tree per se, but also comprises other types of static data structures such as so-called “fixed stride tries” or the like.

Herein, a data structure is “static”, if updates are accomplished by complete reconstruction, i.e. by building a new data structure from scratch.

Herein, the expression “lookup in an arbitrary partition comprising n intervals”, also referred to as “1-dimensional classification”, could logically be briefly explained by the following.
(1) “longest prefix matching (i.e. routing lookup) can be reduced to “most narrow interval matching”
(2) “most narrow interval matching” can be reduced to “first interval matching”
(3) “first interval matching” can be reduced to “only interval matching” (i.e. lookup in an arbitrary partition comprising n intervals)

This means that any method for solving (3) can also be used to solve (2) and any method for solving (2) can also be used to solve (1). Another way of explaining this is that (2) is a more general problem than (1) whereas (3) is the most general problem of them all, Note that all methods described in the present invention support “extended search” thus solving (3) (as well as (2) and (1)).

Thus, the method solves the problems discussed above such as handling keys of different sizes.

According to another aspect of the present invention, there is provided a classifier device for representing a partition of n w-bit intervals associated to d-bit data in a data communications network in a data communications network. The device comprises: a storage for storing a datagram forwarding data structure provided for indicating where to forward a datagram in a network, which data structure is in the form of a tree comprising at least one leaf and possibly a number of nodes including partial nodes, said data structure having a height, corresponding to a number of memory accesses required for looking up a largest stored non-negative integer smaller than or equal to a query key, means for reducing worst storage cost by using a technique for reduction of worst case storage cost that are selectable from: partial block tree compaction, virtual blocks, bit push pulling, block aggregation or split block trees, and variations thereof, means for updating the layered data structure partially including by using a technique for scheduling maintenance work that are selectable from: vertical segmentation and bucket list maintenance.

The device further comprises a partitioned memory, or means arranged to partition the memory such that the memory is designated to store keys having a particular size.

According to a third aspect of the present invention a computer program product is provided, having computer program code means to make a computer execute the above method when the program is run on a computer.

It is appreciated that the computer program product is adapted to perform embodiments relating to the above described method, as is apparent from the attached set of dependent system claims.

Thus, the concept underlying the present invention is to provide reconfigurable block trees. According to a principal aspect of the present invention, this is provided by providing a certain maximum amount of storage capacity for storing a maximal number of keys having a particular size.

Yet another object of the present invention is to present a solution to the problem of handling block trees with different key sizes in a multiple banked memory area where pipe-lining is used to speed up the lookup. The solution to this object is static reconfigurable block trees. This will be described in more detail as follows.

The invention finds application for routing, forensic networking, fire-walling, qos-classification, traffic shaping, intrusion detection, IPSEC, MPLS, etc and as component in technologies to solve any one of the problems mentioned.

Additional features and advantages of the present invention are disclosed by the appended dependent claims.

### BRIEF DESCRIPTION OF THE DRAWINGS

To further explain the invention embodiments chosen as examples will now be described in greater details with reference to the drawings of which:

FIG. 1a illustrates a possible organization of a basic block tree. FIG. 1b illustrates an example of a lookup procedure.

FIG. 2 is a flow-chart showing the method according to an embodiment of the present invention;

FIG. 3a-d illustrates bit push-pulling technique;

FIG. 4 illustrates a layout of a 1024-bit super leaf;

FIG. 5a illustrates stockpiling and 5b the maintenance strategy; and

FIG. 6 illustrates a schematic block diagram of a (hardware) device according to an embodiment of the present invention.

FIG. 7 illustrates a schematic block diagram of a software solution according to an embodiment of the present invention.

### DESCRIPTION OF EMBODIMENTS OF THE INVENTION

Initially, block trees were introduced to implement an IPv4 forwarding table. A block tree, or more precisely a (t, w) block tree is an O(n) space implicit tree structure for representing a partition consisting of intervals of a set of w-bit non-negative integers. It supports search operations in at most t memory accesses for a limited number of intervals.

A basic block tree 10 is characterized by two parameters: the height, or worst case lookup, cost t and the number of bits b that can be stored in a memory block. To distinguish between block trees with different parameters the resulting structure is typically called “a (t, b)-block tree”. Sometimes the parameter t is referred to as the number of levels or the height of the block tree. For example, a complete (1, b)-block tree consists of a leaf and a complete (t, b)-block tree consists of a node followed by b+1 complete (t−1, b)-block trees.

As already disclosed, a basic block tree consists of at least one leaf and possibly a number of nodes if the height t is larger than one. The height t corresponds to the number of memory accesses required for looking up the largest stored non-negative integer smaller than or equal to the input key.

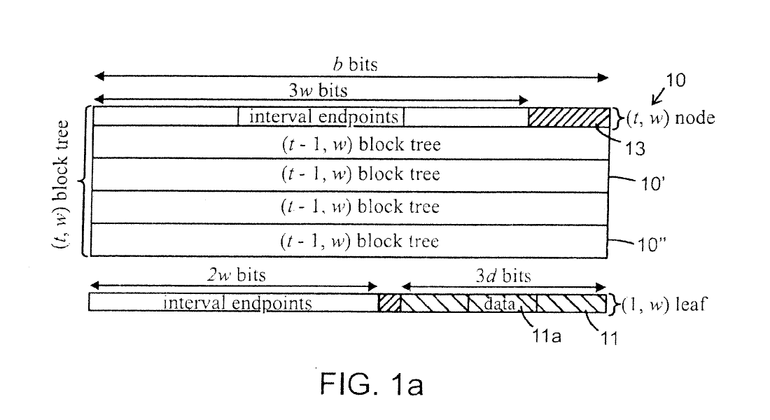

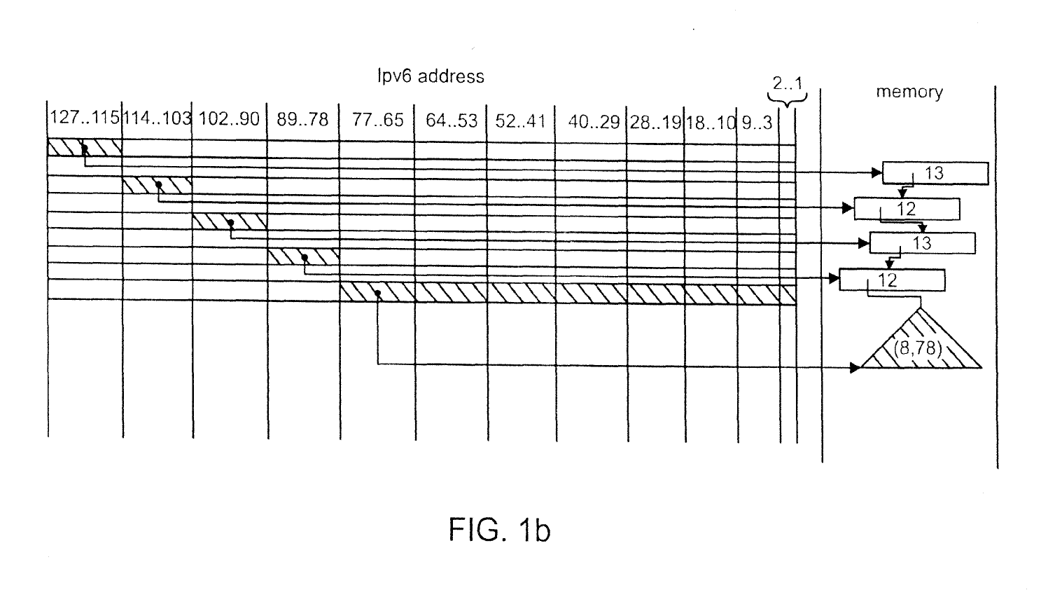

As mentioned above, a basic block tree 10 is either complete or partial. By a complete basic block tree 10 we mean a block tree where the number of integers stored equals the maximum possible number for that particular height t. That is, a complete basic block tree 10, or 10′, or 10″ of height 1 consists of a full leaf 11 and a complete basic block tree of height t larger than 1 consists of a full node 13 and a number of complete basic block trees 10 of height t−1. Each leaf 11 and node 13 is stored in a b-bit memory block. By a full leaf we mean a leaf 11 containing n data fields 11a and n−1 integers where n is the largest integer satisfying n D+(n−1)·W<b+1. By a full node we mean a node 13 containing n integers where n is the largest integer satisfying n·W<b+1. Integers stored in each leaf 11 and node 13 are distinct and stored in sorted order to facilitate efficient search. The number of integers stored in a node 13 is denoted by B. FIG. 1b illustrates an example of a lookup procedure.

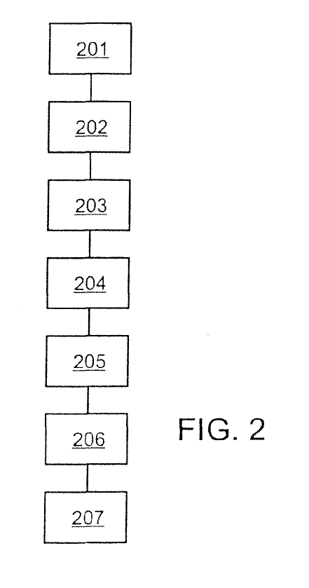

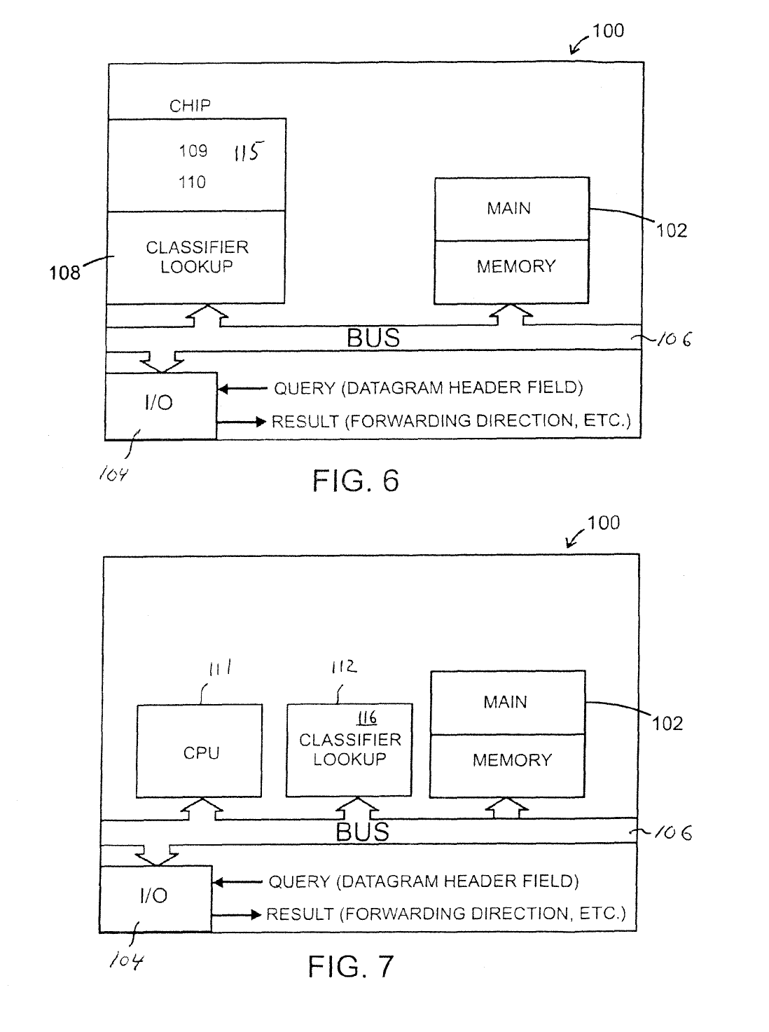

Embodiments of the present invention will now be described with reference to FIG. 1a, and 2 (and FIG. 6), of which FIG. 2 illustrates the method steps and FIG. 6 illustrates a classifier device according to an embodiment of the invention configured in hardware.

In a first step 201, there is provided in a storage comprising a main memory of a device for representing a partition of n w-bit intervals associated to d-bit data in a data communications network, a datagram forwarding data structure 10 provided for indicating where to forward a datagram in a data communications network (not shown). The data structure 10 is in the form of a tree comprising at least one leaf and possibly a number of nodes including partial nodes. As illustrated in FIG. 1a, the data structure 10 has a height h, corresponding to a number of memory accesses required for looking up a largest stored non-negative integer smaller than or equal to an input key. In a second step, 202 worst storage cost is reduced by using a technique for reduction of worst case storage cost that are selectable from: partial block tree compaction, virtual blocks, bit push pulling, block aggregation or split block trees, and variations thereof. In a third step 203, the layered data structure is updated partially by using a technique for scheduling maintenance work that are selectable from: vertical segmentation and bucket list maintenance. In a following step, step 204, a certain maximum amount of storage capacity is provided for storing a maximal number of keys having a particular size. Typically, the storage, herein a memory, is partitioned such that a certain part or portion of the total memory is designated for a particular key size. For example, one block tree can store n1 keys of size w1=32 bits, another block tree can store n2 keys of size w2=64 bits and another block tree can store n3 keys of size w3=128 bits.

Typically, it is desirable from a storage efficiency point of view to represent the block trees such that n1*w1+n2*w2+n3*w3=S, where n1*W1 is the number of keys of size w1, and S is the total amount of memory available.

The storage could be partitioned at system start-up, providing a static system, or alternatively there could be implemented on-the-fly re-partitioning during run-time that smoothly adapts as new keys are inserted. Between these two extremes, a semi-dynamic reconfigurable block tree which supports partitioning at system start-up as well as re-partitioning during run-time could be provided instead.

The technique for reduction of worst case storage cost may comprise: partial block tree compaction, the latter including the sub-steps of:

storing multiple partial nodes in the same memory block, step 204
storing partial nodes across two memory blocks, step 205
moving partial nodes to under utilized memory blocks higher up in the tree, step 206.

When a block tree or a system of block trees storing different key size are stored in a single memory bank (with proper memory management) there is no problem to implement reconfigurable block trees since the differences in out-degree of the block tree nodes only affects how long the “jumps” are to the sub-block trees. However, when using a pipelined memory structure where the size (or allocated space) in each memory bank is customized for one kind of block tree it does not work to store another kind of block tree in that memory because of the different out-degree. For example, suppose that we have w1=32 bits and b=256 bits memory blocks. In this case, we can store 8 keys in one memory block and the out-degree is thus 9. This means that the first memory bank consists of 1 memory block, the second memory bank of 9 memory blocks, the third memory bank of 9*9=81 memory block and so on. Now assume that we try to store a w3=128 bit block tree in the same memory banks. For w3=128 and b=256 we have 1 memory block at the first level and 3 at the second level since we can store two keys in each memory block and thus have an our-degree of 3. Since the memory banks are adapted to w1=32 bits, we get 6 unused memory blocks in the second memory bank. Continuing to the third memory bank make matters even worse as we get 81−9=72 unused memory blocks.

All these method steps related to different embodiments of the present invention will be still further described below, but first is referred to FIG. 6, which is an illustration of a block schematic of a classifier device 100 for performing the method, according to an embodiment of the present invention. The classifier device 100 is implemented in hard-ware. The hard-ware implemented device 100 comprises an input/output unit 104 for transmission of data signals comprising datagrams to or from a source or destination such as a router or the like (not shown). This input/output unit 104 could be of any conventional type including a cordless gate way/switch having input/output elements for receiving and transmitting video, audio and data signals. Data input is schematically illustrated as “query” of one or more data header field(s), and data output as a result such as forwarding direction, policy to apply or the like. Arranged to communicate with this input/output unit 104 there is provided a system bus 106 connected to a control system 108 for instance including a custom classification accelerator chip arranged to process the data signals. The chip provides, or includes, means 115 for memory 102 management, including partitioning of memory 102 space, means for reducing worst storage cost by using a technique for reduction of worst case storage cost that are selectable from: partial block tree compaction, virtual blocks, bit push pulling, block aggregation or split block trees, and variations thereof, and means for updating the layered data structure partially including by using a technique for scheduling maintenance work that are selectable from: vertical segmentation and bucket list maintenance. Typically, the chip 108 could be configured as comprising classifier lookup structure and classifier lookup, typically hardwired.

In an alternative embodiment of the present invention, the classifier device 100 is implemented in software instead. To ease understanding, same reference numerals as already have been used in relation to FIG. 6 will be used as far as possible.

Typically, the control system 108 comprises a processor 111 connected to a fast computer memory 112 with a system bus 106, in which memory 112 reside computer-executable instructions 116 for execution; the processor 111 being operative to execute the computer-executable instructions 116 to:

providing in a storage 102, herein typically the main-memory, a datagram forwarding data structure provided for indicating where to forward a datagram in said network, which data structure is in the form of a block tree, or fixed stride trie, comprising at least one leaf and possibly a number of nodes including partial nodes, said data structure having a height, corresponding to a number of memory accesses required for lookup in an arbitrary partition comprising n intervals;
reducing worst storage cost by using a technique for reduction of worst case storage cost that are selectable from: partial block tree compaction, virtual blocks, bit push pulling, block aggregation or split block trees, and variations thereof; updating the layered data structure partially by using a technique for scheduling maintenance work that are selectable from: vertical segmentation and bucket list maintenance. The device is arranged to partition the storage 102 such that the storage 102 is designated to store keys of different sizes.

The second step 202 will now be described in more detail below, whereby possible techniques for reduction of worst storage cost are described. The techniques could be used separately or in any combination without departing from the invention.

### Partial Block Tree Compaction

In a complete block tree, all memory blocks are fully utilized in the sense that no additional keys can be stored in each node and no additional pairs of keys and data can be stored in the leaves. The number of memory blocks required for storing the intervals is not affected by the construction of the block tree which merely rearranges the interval endpoints. The resulting data structure is therefore referred to as implicit as the structure is implicitly stored in the ordering between the elements. However, this is not true for a partial block tree. In the worst case, there will be t memory blocks which contain only one interval endpoints. If B>1 this means that the total storage overhead resulting from under utilized memory blocks can be as much as t·(B−1) elements. The resulting data structure can thus not be said to be implicit. If, for some reason, the height must be hard coded irrespectively of n the overhead increases to tB for a degenerated t-level block tree containing zero intervals. To make the whole data structure implicit, partial nodes must be stored more efficiently.

This could be provided by means of a technique herein called “partial block tree compaction”, step 202, which can be used to reduce the storage cost for any partial (t, B)-block tree to the same cost as a corresponding complete block tree. This is achieved by combining three sub-methods:
Multiple partial nodes are stored in the same memory block.
Partial nodes are stored across two memory blocks.
Partial nodes are moved to under utilized memory blocks higher up in the tree.

There is at most one partial node at each level. Furthermore, if there is a partial node at a certain level it must be the rightmost node at that level. Let ni be the number of elements in the rightmost node at level i. The sequence n1, n2, . . . , nt is completely determined by n, t, and B. Compaction is performed at each level, starting at level t, and completed when the partial node at level 1 has been compacted. Let mi be the number of additional elements that can be stored in the partially utilized block at level i and j be the level of the next partial node to be compacted. Initially, i.e. before compaction begins, mi=B−ni for all i=1 . . . t and j=t−1. Compaction at level i is performed by repeatedly moving the next partial node to the current memory block. This is repeated as long as nj≦mi. For each node moved, mi is decreased by nj followed by decreasing j by 1. Note that we also have to increase mj to B before decreasing j since moving the node at level j effectively frees the whole block at level j. If mi>0 when compaction halts, some space is available, in the current block, for some of the elements from the next partial node but not for the whole node. Then, the first mi elements from the next partial node are moved to the current memory block, which becomes full, and the last nj−mi elements are moved to the beginning of the next memory block, i.e. the block at level i−1. This is followed by decreasing mi−1 by nj−mi and increasing mj to B. Finally, i is increased by 1 and compaction continues at the next level. Compaction may free the rightmost leaf in the block tree but also create up to t−2 empty memory blocks within the block tree. The final compacted representation is obtained by repeatedly moving the rightmost node to the leftmost free block until all free blocks are occupied. In this representation, all memory blocks are fully utilized except one.

An alternative technique, herein called “virtual blocks” could be employed instead of, or in addition to, the one described above.

### Virtual Blocks

If the size b of the memory blocks and the size of keys and data fit extremely bad together nodes and/or leaves will contain many unused bits even if the tree is implicit according to the definition above. This problem is referred to as a quantization effect. To reduce quantization effects, we can use virtual memory blocks with custom sizes bleaf and bnode for leaves and nodes respectively such 100% block utilization is achieved. By choosing bleaf and bnode less than or equal to b, we can be sure that a custom block straddles at most one b-block boundary. As a result, the worst case cost for accessing a custom block is two memory accesses and thus the total cost for lookup is doubled in the worst case.

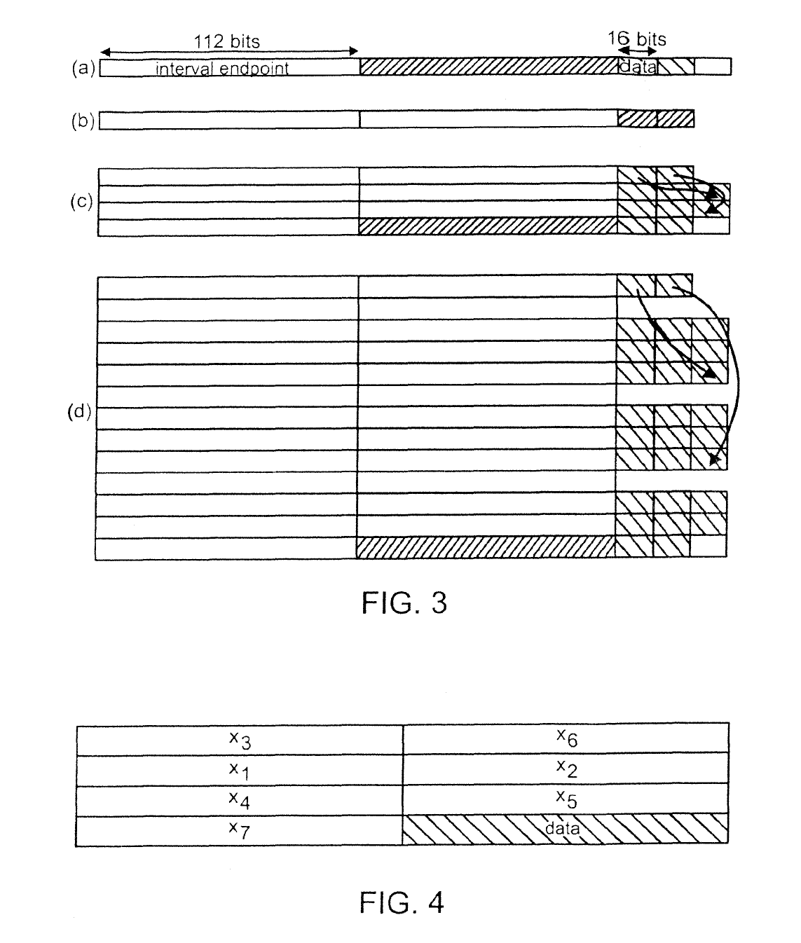

According to yet another embodiment of the present invention, another technique, herein called “bit push pulling could be employed instead or in any combination. This technique is illustrated in FIG. 3a-d.

### Bit Push-Pulling

Another method for reducing quantization effects without increasing the lookup cost is bit push-pulling. Similarly to virtual memory blocks, the idea behind bit push-pulling is to emulate memory blocks with some other size than b in order to increase block utilization. Let nleaf=n (1, w, b, d) and nnode=floor(b/w). In each leaf and node we have bleaf=b−(nleaf·(d+w)−w) and bnode=b−nnode·w unused bits respectively. If bnode=nnode·((w+d)−bleaf), each leaf below a parent node at level 2, except the last leaf, can be extended to b+(w+d)−bleaf bits by storing (w+d)−bleaf bits in the parent node. In this way, the first nnode leaf blocks as well as the node block becomes 100% utilized. The missing bits from the leaves are pushed upwards to the next level during construction and pulled downwards when needed during lookup, hence the name bit push-pulling. One of the leaves is leaved unextended. By doing so, we can apply the technique recursively and achieve 100% block utilization for nnode sub-trees of height 2 by pushing bits to the node at level 3. As the number of levels increases, the block utilization in the whole block tree converges towards 100%.

As an example, we can use bit push-pulling to reduce the worst case storage cost for 112-bit keys with 16-bit data and 256-bit memory blocks. For w=104 we have 100% leaf utilization (2·104+3·16=256) but only 87.5% node utilization. We can therefore suspect that the low cost of 128 bits per interval can be reached for some w>104 by some clever modification of the block tree. Consider such a w and imagine a (t, w)-block tree where leafs and nodes are organized in the same manner as for w=104 and for now ignore how this is achieved as we will come to that later. The total number of utilized bits B(t) in our imaginary block tree is defined by the recurrence equation

B(1)=2w+3·16

B(t)=2w+3B(t−1)

and the number of blocks is given by s(t, 104) since the organization of nodes and leafs are the same. By solving the equation B (t)=b·s (t, 104) for w we get

w=3t·(128−16)−128 3t−1=112, as t→∞.

Hence, for w=112, 100% utilization would be achieved and it is therefore meaningless to consider larger values than 112. Let us focus on w=112 and see what can be achieved. FIG. 3 (a) shows a leaf containing an interval endpoint, two data fields and an area of the same size as the interval endpoint that is unused (black). If we had some additional bits for representing a third data field, the unused bits could be used to represent a second endpoint. The resulting leaf would be organized in the same way as leafs in (t, 104) block trees. Missing bits are shown using dashed lines in the figure. The unused bits in the node illustrated in FIG. 3 (b) correspond to two data fields. Each node has three children and hence three leaves share parent node. We can store the missing data fields from two of the leafs in the unused data fields in the node to obtain a tree of height two which is missing space for one data field as shown in FIG. 3(c). In FIG. 3(d), we have applied the technique recursively to create a tree of height three which is also missing space for one data field. Conceptually, we emulate 256+16=272-bit blocks for storing the leaves and 256−2·16=224-bits blocks for storing the nodes.

For this to work when all blocks are of size 256 the bits from the leaves are pushed upwards in the tree during construction and pulled downwards if/when needed during lookup. By using this bit push-pull technique we can implement modified (t, 112)-block trees of arbitrary height with utilization that converges to 100%. The maximum number of intervals and maximum relative size are given by bn (t, 112)=bn (t, 104)=3t and c (t, 112)=c (t, 104)=128.

According to yet another embodiment of the present invention, another technique herein called “virtual blocks” could be employed instead or in combination with the ones already disclosed.

### Block Aggregation

The block aggregation technique is simpler and less elegant but can be used together with bit push-pulling for instance. If bnode <nnode·((w+d)−bleat), we can use block aggregation to construct super leaves and super nodes stored in aleaf b and anode·b bits blocks respectively. If bleaf and w+d are relatively prime, bleaf can be used as generator and aleaf·bleaf can be used to construct any integer modulo w+d. Otherwise, aleaf=(w+d)/bleaf leaf blocks are combined into one super leaf with 100% utilization. For nodes, the method is similar. If bnode and w are relatively prime, bnode can generate any integer modulo w, 2w, 3w, and so on. In particular, the exact number of unused bits required for bit push-pulling can be generated. Otherwise, anode=w/bnode blocks are combined into a super node with 100% utilization. Bit push-pulling have only positive effect on the lookup performance since the size of the set of intervals we can handle increases without causing additional memory accesses for the lookup. When using block aggregation we can expect a slight increase of the lookup cost since we may have to search large aggregated blocks. However, since an aggregated block can be organized as a miniature block tree and we never need to aggregate more than b blocks, the local lookup cost is ceil(LOG(b̂2/w))+1, where LOG is the logarithm with base floor(b/w). Note that we assume that the last memory access (the added 1) straddles a block boundary. Even in the worst case, this is only marginally more expensive than the lookup cost in a non-implicit block tree where block aggregation is not used.

As an example, we can use block aggregation to improving compression for 128-bit keys with 16-bit data stored in 256-bit memory blocks. The cost for using basic block trees is 192 bits per interval—which would be optimal for d=64 bits data—when w>104 and drops to 128 bits per interval when w=104. It would be possible to implement more efficient block trees for w=128 if we could use larger blocks. If we could use 2·128+3·16 =304-bit blocks for the leafs while keeping the 256-bit block for the nodes, the maximum relative size of a 128-bit block tree drops to 144 and the ideal compression ratio (=optimal storage cost) is reached. This can be easily achieved in a hardware implementation where the different levels of the block tree are stored in different memory banks that can have different block sizes. However, if we are stuck with 256-bit blocks the only option is to somehow emulate larger blocks. Assume that two memory accesses can be spent for searching a block tree leaf rather than only one memory access. Two blocks can then be combined into a 512-bit super leaf containing three 128-bit interval endpoints and four 16-bit data fields. Of the total 512 bits, we utilize 3·128+4·16=448 corresponding to 81.25% which is an improvement compared to 62.5%. Using the same technique, 768 bit blocks can be emulated with 95.8% utilization and 1024-bit blocks with 100% utilization (7·128+·8·16=1024). In a 1024 bits block, we can store 7 keys x1, x2, . . . , x7, where xi<xi+1, and 8 data fields. Searching a super leaf in four memory accesses is straightforward as there are four blocks. To reduce the search cost to three memory accesses we organize the super leaf (See FIG. 4) as follows: the first block contains x3 and x6, the second block contains x1 and x2, the third block contains x4 and x5, and the fourth block contains x7 and the 8 data fields. By searching the first block in one memory access we can determine in which of the other three blocks to spend the second memory access. The third memory access is always spent in the fourth block. We will refer to this data structure as modified (t, 128)-block tree. The maximum number of intervals that can be stored is bn (t, 128)=3t−3·8 and since both nodes and leafs are 100% utilized, the maximum relative size is the ideal c (t, 128)=w+d=144 bits per interval.

### Split Block Trees

Consider a collection of small (t, w)-block trees representing n1, n2, . . . , nF intervals. If the maximum relative size for the collection as a whole is too high we can reduce the quantization effects by using split block trees. The idea is to store the block tree in two parts called the head and the tail. The head contains the relevant information from all partially used nodes and leaf and a pointer to the tail which contains complete block trees of height 1, height 2, and so on. The tail consists of memory blocks that are fully utilized and a forest of block trees is stored with all the tails, block aligned, in one part of the memory whereas the heads are bit aligned in another part of the memory. For the collection as a whole, at most one memory block is under utilized. There can be at most one partially used node at each level and at most one partially used leaf. By recording the configuration of the head, the partial nodes and leaf can be tightly packed together (at the bit level) and stored in order of descending height. Moreover, the only requirement on alignment of the head is that the tail pointer and the partial level t node lies in the same memory block. We can then search the partial level t node in the first memory access, the partial level t−1 node in the second, and so on. It does not matter if we cross a block boundary when searching the partial t−i level node since we have already accessed the first of the two blocks and only have to pay for the second access. As a result, the cost for reaching the partial t−i node is at most i memory accesses and we have at least t−i memory accesses left to spend for completing the lookup. If n is very small, e.g. the total number of blocks required for storing the head and the tail is less than t, the quantization effects can be reduced even further by skipping the tail pointer and storing the head and the tail together.

Now, a set of techniques for scheduling maintenance work, corresponding to the third step 203 will be described in more detail.

### Vertical Segmentation

To handle large block trees, a technique called vertical segmentation could be implemented, where the tree is segmented into an upper part and a lower part. The upper part consists of a single block tree containing up to M intervals and the lower part consists of up to M block trees where each block tree contains up to N intervals. To keep the overall tree structure reasonably balanced, while limiting the update cost for large n, we will allow reconstruction of at most one block in the upper part plus complete reconstruction of two adjacent block trees in the lower half, for each update.

### Bucket List Maintenance

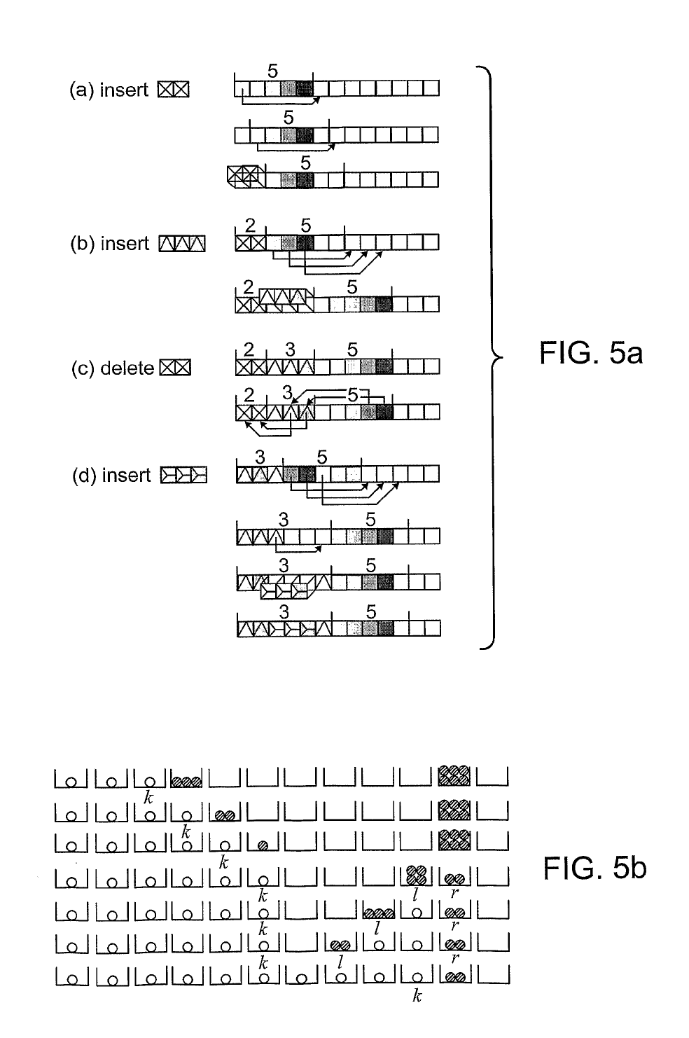

Now is referred to FIG. 5b. Let u(M,N) be our update cost budget, i.e., the maximum number of memory accesses we are allowed to spend on one update. We consider the data structure to be full when additional reconstruction work would be required to accommodate for further growth. The main principle behind our maintenance strategy is to actually spend all these memory accesses on each update in the hope of postponing the first too expensive update as much as possible.

First, let us present the problem in a slightly more abstract form. Let B1, B2, . . . , BM be a number of buckets corresponding to the M block trees in the lower part. Each bucket can store up to N items corresponding to N intervals. Let xi be an interval endpoint in the upper tree and x[i,1], . . . , x[i, mi] belonging to the interval [x[i−1], x[i]−1] be the interval endpoints in the lower tree corresponding to bucket Bi. Clearly, xi=x[i] works as a separator between bucket Bi and bucket B[i+1]. Since we are allowed to reconstruct one block in the upper tree and reconstruct two adjacent trees in the lower part, we can replace xi in the upper tree by one of x[i,1], . . . , x[i, mi], x[i+1,1], . . . , x[i+1,mi+1] and build two new block trees from scratch from the remaining interval endpoints. This corresponds to moving an arbitrary number of items between two adjacent buckets. When an item is inserted into a full bucket, it fails and the system of buckets is considered full. Only insertions needs to be considered since each delete operation reduces n by 1 while financing the same amount of reconstruction work as an insert operation. The role of a maintenance strategy is to maximize the number items that can be inserted by delaying the event of insertion into a full bucket as much as possible. We perform insertions in a number of phases, where the current phase ends either when a bucket becomes full or when M items have been inserted, whichever happens first. Consider a phase where m≦M items have been inserted. For each item inserted we can move an arbitrary number of items between two adjacent buckets. This is called a move.

Proposition 10 (a) m−1 moves is sufficient to distribute these m items evenly, i.e. one item per bucket, no matter how they were inserted, (b) these m−1 moves can be performed after the current phase.

Initially, we have 0 items in each bucket or equivalently space for N0=N items. Provided that N≧M, M items will be inserted in the first phase. By Proposition 10, these can be evenly distributed among the buckets, by performing the maintenance after the first phase. When the next phase begins, there will be 1 item per bucket or equivalently space for N1=N0−1=N−1 additional items. This can be repeated until Ni=N−i<M, and the total number of items inserted up to this point is M·(N−M). In phase Ni, the smallest number of elements that can be inserted is M−1 if all items falls in the same bucket and in the remaining phases the number of insertions is reduced by 1 in each phase until only one item can be inserted. According to Proposition 10, maintenance can still be performed but only for a limited number of buckets. If we focus maintenance efforts to the buckets where insertions occur we can still guarantee that the available space does not decrease by more than one item for each phase. Hence, an additional sum(i, i=1 . . . M)=M·(M+1)/2 items can be inserted yielding a total of MN−M·(M−1)/2 items. For each insertion in the current phase we can perform one move (of maintenance work) for the previous phase. The difference in number of inserted items is at most 1 between the previous and the current phase. By Proposition 10 (a), the number of insertions of the current phase is thus sufficient to pay for the maintenance for the previous phase and Proposition 10 (b) follows. It remains to prove Proposition 10 (a). To distinguish between items that have not been maintained from the previous phase and items being inserted in the current phase we colour the items from the previous phase blue and the inserted items red. First consider the case when m=M. The maintenance process basically operates on the buckets in a left to right fashion (with an exception). Let Bi be the number of blue items in bucket i, and k the index of the rightmost completed bucket −k is initially zero. We start in rightward mode: Find the leftmost bucket r satisfying sum(Bj, j=k+1 . . . r)≦r−k. If r=k+1, move Br−1 (possibly zero) item from bucket r to bucket r+1 and increase k by 1 since bucket r is completed. Otherwise (r>k+1), set l=r and enter leftward mode. In leftward mode the maintenance process works as follows: If l=k+1, k is increased to r−1 and we immediately enter rightward mode. Otherwise, l−(k+1)−sum(Bj, j=k+1 . . . l−1) items are moved from bucket l to bucket l−1, and l is decreased by 1. FIG. 5b illustrates how completion of three buckets is achieved in three steps in rightward mode followed by completing four buckets in leftward mode in the last four steps. Switching between rightward and leftward mode is free of charge. For each move performed in rightward mode one bucket is completed. In leftward mode there are two cases. If there is only one move before switching to rightward mode, one bucket is completed. Otherwise, no bucket is completed in the first move but this is compensated by completing two buckets in the last. For each move between the first and the last move one bucket is completed. To summarize this, each move completes one bucket and hence there are M−1 buckets that contains exactly 1 blue item each after M−1 moves. There are M blue items in total and hence the last bucket must also contain 1 blue item (and is thus also completed). We have proved Proposition 10 (a) for m=M. If m<M, we can use a left to right greedy algorithm to partition the set of buckets into a minimum number of regions where the number of buckets in each region equals the total number of blue items in that region. Some buckets will not be part of a region but this is expected since less than M blue items are available. Within each region we run the maintenance process in exactly the same way as for m=M. This concludes the proof of Proposition 10 (a) as well as the description and analysis of our maintenance strategy.

### Stockpiling

Consider the general problem of allocating and deallocating memory areas of different sizes from a heap while maintaining zero fragmentation. In general, allocating a contiguous memory area of size s blocks is straightforward—we simply let the heap grow by s blocks. Dellocation is however not so straightforward. Typically, we end up with a hole somewhere in the middle of the heap and a substantial reorganization effort is required to fill the hole. An alternative would be to relax the requirement that memory areas need to be contiguous. It will then be easier to create patches for the holes but it will be nearly impossible to use the memory areas for storing data structures etc. We need a memory management algorithm which is something in between these two extremes. The key to achieve this is the following observation: In the block tree lookup, the leftmost block in the block tree is always accessed first followed by accessing one or two additional blocks beyond the first block. It follows that a block tree can be stored in two parts where information for locating the second part and computing the size of the respective parts is available after accessing the first block. A stockling is a managed memory area of s blocks (i.e. b bits blocks) that can be moved and stored in two parts to prevent fragmentation. It is associated with information about its size s, whether or not the area is divided in two parts and the location and size of the respective parts. Moreover, each stockling must be associated with the address to the pointer to the data structure stored in the stockling so it can be updated when the stockling is moved. Finally, it is associated with a (possibly empty) procedure for encoding the location and size of the second part and the size of the first part in the first block. Let ns be the number of stocklings of size s. These stocklings are stored in, or actually constitutes a, stockpile which is a contiguous sns blocks memory area. A stockpile can be moved one block to the left by moving one block from the left side of the stockpile to the right side of the stockpile (the information stored in the block in the leftmost block is moved to a free block at the right of the rightmost block). Moving a stockpile one block to the right is achieved by moving the rightmost block to the left side of the stockpile. The rightmost stockling in a stockpile is possibly stored in two parts while all other stocklings are contiguous. If it is stored in two parts, the left part of the stockling is stored in the right end of the stockpile and the right end of the stockling at the left end of the stockpile. Assume that we have c different sizes of stocklings s1, s2, . . . , sc where si>si+1. We organize the memory so that the stockpiles are stored in sorted order by increasing size in the growth direction. Furthermore, assume without loss of generality that the growth direction is to the right. Allocating and deallocating a stockling of size si from stockpile i is achieved as follows:

### Allocate si.

Repeatedly move each of stockpiles 1, 2, . . . , i−1 one block to the right until all stockpiles to the right of stockpile i have moved si blocks. We now have a free area of si blocks at the right of stockpile i. If the rightmost stockling of stockpile i is stored in one piece, return the free area. Otherwise, move the left part of the rightmost stockling to the end of the free area (without changing the order between the blocks). Then return the contiguous si blocks area beginning where the rightmost stockling began before its leftmost part was moved.

### Deallocate si.

Locate the rightmost stockling that is stored in one piece (it is either the rightmost stockling itself or the stockling to the left of the rightmost stockling) and move it to the location of the stockling to be deallocated. Then reverse the allocation procedure.

In FIG. 5a, we illustrate the stockpiling technique in the context of insertion and deletion of structures of size 2 and 3 in a managed memory area with stockling sizes 2, 3 and 5. Each structure consists of a number of blocks and these are illustrated by squares with a shade of grey and a symbol. The shade is used to distinguish between blocks within a structure and the symbol is used to distinguish between blocks from different structures. We start with a 5-structure and then in (a) we insert a 2-structure after allocating a 2-stockling. Observe that the 5-structure is stored in two parts with the left part starting at the 6th block and the right part at the 3rd block. In (b) we allocate and insert 3 blocks and as a result, the 5-structure is restored into one piece. A straightforward deletion of the 2-structure is performed in (c) resulting in that both remaining structures are stored in two parts. Finally, in (d) a new 3-structure is inserted. This requires that we first move the 5-structure 3 blocks to the right. Then, the left part (only the white block in this case) of the old 3-structure is moved next to the 5-structure and finally the new 3-structure can be inserted. The cost for allocating an si stockling and inserting a corresponding structure is computed as follows. First, we have to spend (i−1)·si memory accesses for moving the other stockpiles to create the free space at the end of the stockpile. We then have two cases: (i) Insert the data structure directly into the free area. The cost for this is zero memory accesses since we have already accessed the free area when moving the stockpiles (insertion can be done simultaneously while moving the stockpiles). (ii) We need move the leftmost part of the rightmost stockling. However, it occupies an area which will be overwritten when inserting the data structure. Therefore, we get an additional si memory accesses for inserting the data structure. For deallocation, we get an additional cost of si memory accesses since we may need to overwrite the deleted stockling somewhere in the middle of the stockpile. We also need to account for the cost for updating pointers to the data structures that are moved. Since the stockpiles are organized by increasing size, at most one pointer needs to be updated for each stockpile moved plus two extra pointer updates in the current stockpile. It follows that the cost for inserting a si blocks data structure when using stockpile memory management is isi+(i−1)+2=isi+i+1 memory accesses and the cost for deletion is (i+1)·si+(i−1)+2=(i+1)·si+i+1 memory accesses.

Stockpiling can be used also if it is not possible to store data structures in two parts. In each stockpile, we have a dummy stockling and ensure that it is always the dummy stocklings that are stored in two parts after reorganization.

As an example of how stockpiling is used together with bucket list maintenance and vertical segmentation, we show how to design a dynamic (12, 128)-block tree. To implement the upper part of a vertically segmented (12, 128)-block tree we use a standard (5, 128)-block tree, i.e., without super leafs, with p bits pointers instead of d bits data. For the lower part we choose modified (7, 128)-block trees. The total lookup cost for the resulting data structure is still 12 memory accesses. For this combination, we have N=n(5, 128)=162, M=n(7, 128)=648 and the total number of intervals we can store is 91935.

By using stockpiling we can limit the cost for insertion and deletion of an ai-block structure to at most iai+i+1 memory accesses and (i+1)·ai+i+1 memory accesses, respectively, where a1>a2> . . . >ak are the different allocation units available. In our case, the maximum allocation unit is s (7, 128)=364 blocks and assuming that we require maximum compression, we must use 364 different allocation units. As a result, ai=364−(i−1) and the worst-case cost for inserting an a 182=364−(182−1)=183-block structure is 33489 memory accesses. To reduce the memory management overhead we must reduce the number of allocation units. This is achieved by decreasing the compression ratio. When using vertical segmentation, we waste 128 bits in each leaf in the upper part for storing pointers and some additional information that is required when using Stockpiling. By using these bits we can also store the variables k, r, and l required for running the maintenance of each block tree in the lower part in-place. The total cost for this is 162·128=20736 bits which is amortized over 91935 intervals yielding a negligible overhead per interval. Hence, the maximum relative size is roughly 144 bits per intervals also with vertical segmentation. Suppose that we increase storage by a factor of C, for some constant C>1. We can then allocate (and use) 364 blocks even if we only need A blocks, provided that AC 364. Furthermore, we can skip all allocation units between A−1 and 364. By applying this repeatedly, we obtain a reduced set of allocation units where ai=ceil(a1/Ĉ(i−1)). To further demonstrate this, we choose C=2, which corresponds to a 100% size increase, and perform a thorough worst-case analysis of the update cost. The first step is to compute the set of allocation units and the insertion and deletion cost for each allocation unit (see Table 9). Before investigating the worst-case update cost, we observe that 364+730=1094 memory accesses is a lower bound on the update cost which is independent of C. This is a result from simply reconstructing one 364-block structure without involving the memory manager and simultaneously de-allocating the other 364-block structure at a cost of 730 memory accesses. For our particular choice of C, an additional 367 memory accesses for allocating a 182-block structure must be added to the lower bound resulting in an actual lower bound of 1461 memory accesses. In the worst-case, an insertion of one allocation unit and a deletion of another is required for both block trees. However, not all combinations of insertion and deletion costs are possible. The first observation is that deleting of one allocation unit is followed by inserting the next smaller or the next larger allocation unit. We can also exclude the combinations where the size of the deleted allocation unit from one block tree is the same as the inserted allocation unit from the other block tree as this eliminates one deallocation cost. By comparing costs for the remaining combinations in the table above, we find that the worst-case occurs when deleting a 364-block and a 91-block structure and inserting two 182-block structures resulting in a total cost of 730+368+2·367=1832 memory accesses. Adding the single memory access required for updating the upper part yields a total worst-case incremental update cost of 1833 memory accesses for a 100% size increase. To provide a better understanding of the possible trade-offs between compression ratio and guaranteed update costs we have performed these computations for various values of C and the result are presented in Table 10. These figures should be compared with 134322 memory accesses which is the update cost obtained for C=1. Also note that for C≧3.31, the worst-case update cost equals the general lower bound computed above plus the cost for allocating an a2-blocks structure.

TABLE 9
Insertion and deletion costs for the different
allocation units obtained for C = 2.

| i | 1 | 2 | 3 | 4 | 5 | 6 | 7 | 8 | 9 | 10 |
|---|---|---|---|---|---|---|---|---|---|---|
| aᵢ | 364 | 182 | 91 | 46 | 23 | 12 | 6 | 3 | 2 | 1 |
| icostᵢ | 366 | 367 | 277 | 189 | 121 | 79 | 50 | 33 | 28 | 21 |
| dcostᵢ | 730 | 549 | 368 | 235 | 144 | 91 | 56 | 36 | 30 | 22 |

TABLE 10
Relation between storage and update costs.

| C | Worst-case update cost |
|---|---|
| 1.1 | 6537 |
| 1.25 | 3349 |
| 1.5 | 2361 |
| 1.75 | 2049 |
| 2 | 1833 |
| 2.5 | 1561 |
| 3 | 1393 |
| 4 | 1280 |

Throughout this application we will use the term “routing table”, “partition of intervals”, and “set of intervals” interchangeably to means the input data from which the classification data structure is built.

### Static Reconfigurable Block Trees

Let w1, w2, w3, . . . wi be the different key sizes that need to be managed in a block tree system stored in a number of pipe-lined memory banks where bank i is comprised of si blocks of size b.

We want to partition the available memory such that we can store the different block trees with a minimum of wasted memory. To achieve this, we use vertical segmentation and allocate space for one complete upper part block tree for each key size. This will affect the first memory banks and there will be a small amount of memory wasted there since for some applications only one key size may be used while still having allocated space for upper part block trees for all the other key sizes. However, due to the exponential growth of block trees as one moves downwards in the trees, the total amount of wasted space for upper block trees is negligible.

To simplify this description we therefore assume that all memory banks are used to store lower part block trees. Let wmax=max(w1, . . . , wi) be the largest key and F=1+floor(b/wmax) where b is the size of each memory block (assumed to be the same across all memory banks). Now, for each lower part block tree, we allocate 1 block in the first memory bank, F blocks in the second memory bank, F*F blocks in the third memory bank and so on. Each block in each memory bank is belongs to a specified lower part block tree. In this way, the memory is partitioned into memory for a number of lower part block trees. We call each such part of the memory a pyramid. To summarize, we now have M pyramids corresponding to the lower part block trees described above.

For w=wmax, it is straightforward to store each lower part block trees in a pyramid since these are configured for w=wmax. We will show below how to store also lower part block trees for smaller w in pyramids but for now, let us just assume that we can achieve this.

For each key size wi, there will be a maximum number of keys Ni that can be represented by a lower part block tree stored in a pyramid. Partitioning the memory to accommodate for maximum sized block trees for the different key sizes can therefore be achieved by allocating a certain number of pyramids Mi to each key size wi and then use the bucket list maintenance formula (Mi*Ni−Mi*(Mi−1)/2) described above to compute how may keys that can be stored for each key size.

We have now described how to configure the pyramids according to the maximum key size and how to partition the total available memory by partitioning the set of pyramids. It remains to show how to map a block tree for keys wi such that floor(b/wi)>floor(b/wmax) into a pyramid memory.

In a pyramid, we can order all memory blocks in all banks by letting the first block in the first memory bank be the first block, followed by all blocks in the second memory bank (in order), followed by the block in the third memory bank (in order) and so on. Now consider a wi such that a wi block tree has larger out-degree than a wmax block tree. We can store the memory blocks of such a block tree in a pyramid by writing the block tree to the pyramid block in order as if they were a sequential list of memory blocks in one single memory bank. Clearly, it is possible to store a wi block tree in this way. However, we must also make sure that we can perform lookup without causing problems in the memory banks, and in particular that we do not need to access the same memory bank twice. The first memory access takes place in the first memory bank so this is not a problem. As for the second memory access, it may take place in the second memory bank, but it may also take place in the third, fourth, fifth etc memory bank depending on the relationship between the out-degree of wmax block trees and wi block trees. Since the out degree of wmax block trees corresponds to the width of each pyramid level and wi block trees has greater out-degree, two memory accesses in a wi block tree cannot take place in the same pyramid level. The reason is that the greater out-degree of wi-block trees guarantees that the jump forward in the ordering of blocks in a pyramid is long enough to move at least down to the next level in the pyramid.

Note: If pyramids were configured according to a smaller key, the opposite situation would occur meaning that multiple accesses in wmax block trees would possibly occur in the same memory bank thus causing the pipelining not to work.

To implement lookup in a pyramid is straight forward. It is essentially the same as lookup in a single memory bank except that a mapping is required from the linear order of the blocks of the pyramid to the actual block in the right memory bank. This is a simple computation.

The present invention has been described by given examples and embodiments not intended to limit the invention to those. A person skilled in the art recognizes that the attached set of claims sets forth other advantage embodiments.

### LIST OF ABBREVIATIONS USED IN THIS SPECIFICATION

BBT Basic block tree
SBT Static block tree
SP Stockpiling
DBT Dynamic block tree
FST Fixed stride trie
SHT Static hybrid tree
SHBT Static hybrid block tree
DHBT Dynamic hybrid block tree
DHT Dynamic hybrid tree
ASC Address space compression

1. A method for representing a partition of n w-bit intervals associated to d-bit data in a data communications network, said method comprising the steps of:
providing in a storage having a certain amount of storage capacity, a datagram forwarding data structure provided for indicating where to forward a datagram in said network, which data structure is in the form of a block tree, or fixed stride trie, comprising at least one leaf and possibly a number of nodes including partial nodes, said data structure having a height, corresponding to a number of memory accesses required for lookup in an arbitrary partition comprising n intervals,
reducing worst storage cost by using a technique for reduction of worst case storage cost that are selectable from: partial block tree compaction, virtual blocks, bit push pulling, block aggregation or split block trees, and variations thereof,
updating the layered data structure partially by using a technique for scheduling maintenance work that are selectable from: vertical segmentation and bucket list maintenance, further comprising
using a certain maximum amount of storage capacity for storing a maximal number of keys having a particular size, (step 204), wherein the storage is partitioned such that n1*w1+n2*w2 . . . +nn*wn=S, where n1*W1 is the number of keys of size w1, n2*W2 is the number of keys of size w2, nn*Wn is the number of keys of size wn and S is the total amount of storage available.

2. The method according to claim 1, comprising the step of partitioning the storage such that a certain part or portion of the total storage is designated for a particular key size.

3. The method according to claim 1, wherein the storage is partitioned at system start-up.

4. The method according to claim 1, wherein the storage is partitioned during run-time.

5. The method according to claim 1, wherein the storage is partitioned to provide a semi- dynamic reconfigurable block tree.

6. A classifier device for representing a partition of n w-bit intervals associated to d-bit data in a data communications network in a data communications network, which device comprises:
a storage for storing a datagram forwarding data structure provided for indicating where to forward a datagram in a network, which data structure is in the form of a tree comprising at least one leaf and possibly a number of nodes including partial nodes, said data structure having a height, corresponding to a number of memory accesses required for looking up a largest stored non-negative integer smaller than or equal to a query key;
means for reducing worst storage cost by using a technique for reduction of worst case storage cost that are selectable from: partial block tree compaction, virtual blocks, bit push pulling, block aggregation or split block trees, and variations thereof; and
means for updating the layered data structure partially including by using a technique for scheduling maintenance work that are selectable from: vertical segmentation and bucket list maintenance, which device further comprises means arranged to partition the storage such that the storage is designated to store keys of different sizes, wherein the storage, being a memory, is partitioned such that n1*w1+n2*w2 . . . +nn*wn=S, where n1*W1 is the number of keys of size w1, n2*W2 is the number of keys of size w2, nn*Wn is the number of keys of size wn and S is the total amount of storage available.

7. A classifier device according to claim 6, wherein the storage, being a memory, is partitioned such that the memory is partitioned at system start-up.

8. A classifier device according to claim 6, wherein the storage, being a memory, is partitioned such that the memory is partitioned during run-time.

9. A classifier device according to claim 6, wherein the storage, being a memory, is partitioned such that the memory is partitioned to provide a semi-dynamic reconfigurable block tree.

10. A computer program product directly loadable into the internal memory of a digital computer, characterized in that said product comprises software code means for performing the step of claim 1.

11. A computer program product comprising a computer readable medium, characterized in that, on said medium it is stored computer program code means, when it is loaded on a computer, to make the computer performing the step of claim 1.
